(19) United States
(12) Patent Application Publication
(10) Pub. No.: US 2018/0135614 A1
(43) Pub. Date: May 17, 2018

(54) SHOCK DAMPENING PUMP

(71) Applicant: Black Night Enterprises, Inc., Delta, UT (US)

(72) Inventor: Neldon P. Johnson, Delta, UT (US)

(73) Assignee: Black Night Enterprises, Inc., Delta, UT (US)

(21) Appl. No.: 15/354,829

(22) Filed: Nov. 17, 2016

(51) Int. Cl. F04B 39/00; F04B 9/02; F04B 19/22; F04B 35/01; F04B 39/12; F04B 53/14; F04B 53/16; F16C 29/00; F16F 13/00; F16F 15/02

(52) U.S. Cl. CPC F04B 39/0027; F04B 9/02; F04B 19/22; F04B 35/01; F04B 39/12; F16C 2360/42; F04B 53/16; F16C 29/002; F16F 13/007; F16F 15/022; F04B 53/14

(57) ABSTRACT

A positive displacement, shock dampening, plunger pump having a plunger chamber with a pressure chamber and a shock chamber, the plunger chamber having a plunger chamber longitudinal wall and the shock chamber having a shock chamber end wall. The plunger pump has a shock bearing slidably positioned in the plunger chamber and a shock spring positioned in the shock chamber between the shock bearing and the shock chamber end wall. The plunger pump has a pump plunger reciprocally positioned in the plunger chamber and extending from the shock chamber to the pressure chamber through a plunger port in the shock bearing. The shock bearing is in slidable contact with the plunger chamber longitudinal wall and the plunger longitudinal surface. The plunger pump has a reciprocating drive connection mechanism for interconnecting the pump plunger with a plunger drive mechanism.

### BACKGROUND OF INVENTION

This invention is in the field of high-pressure, positive displacement pumps, and, in particular in the field of high-pressure plunger pumps.

There are numerous prior art pumps, including numerous prior art plunger pumps for high pressure fluids. High pressure fluid pumping presents some difficult challenges, the most significant of which are perhaps the high temperatures generated and the shock waves and shock loading which are common for high pressure and high pump cycle rate pumping, cycle rate hereafter being referred to as revolutions per minute or “RPM”. These issues pose serious challenges to the durability, reliability, efficiency and functionality of high pressure plunger pumps. Prior art attempts to address these issues have met with varying degrees of success.

It is an objective of the present invention to provide a positive displacement, plunger pump with improved high pressure and temperature durability, reliability, and functionality.

It is a further objective of the present invention to provide a positive displacement, high-pressure, plunger pump with improved shock dampening capabilities.

It is a still further objective of the present invention to provide a positive displacement, plunger pump with enhanced efficiency and performance due to improved shock dampening capabilities.

### SUMMARY OF INVENTION

A preferred embodiment of high pressure, high temperature, shock pressure dampening plunger pump of the present invention, hereinafter referred to as a “shock pump,” has a pressure chamber with a pressure chamber intake port and a pressure chamber outlet port. An intake check valve positioned upstream of the pressure chamber intake port may provide for object fluid to flow into the pressure chamber during down strokes of the pump plunger while preventing outflow of object fluid through the intake port during the up-strokes of the pump plunger. Similarly, an outflow check valve may provide for object fluid to flow from the pressure chamber through the pressure chamber outlet port during up-strokes of the pump plunger while preventing inflow of object fluid through the outlet port during the down strokes of the pump plunger.

A pump plunger is positioned partially in the pressure chamber and partially in a shock chamber, in a plunger reciprocating position by a plunger rod which passes through a plunger rod port in a shock chamber end wall and connects the pump plunger to a plunger drive mechanism.

A shock bearing assembly may incorporate a shock bearing which may have a shock bearing periphery which is in slidable contact in a shock bearing peripheral contact surface with the shock chamber longitudinal wall, and a shock bearing inside surface which is in slidable contact with the plunger longitudinal surface of the pump plunger in the plunger port.

The shock bearing assembly may incorporate a shock dampening mechanism which incorporates a bearing dampener mechanism. The bearing dampener mechanism may incorporate a shock spring, may incorporate a hydraulic dampening system, or may incorporate a hybrid dampener assembly incorporating a shock spring and a hydraulic dampener assembly. An external fluid dampening assembly may be incorporated with a hydraulic dampener assembly or a hybrid dampener assembly of an alternative embodiment of the shock pump.

For a preferred embodiment of the bearing dampener mechanism, as the object fluid, which may be compressible or non-compressible fluid, is introduced to the pressure chamber during the plunger down stroke as the pump plunger moves to plunger intake position, the diminished fluid pressure in the pressure chamber may result in the shock bearing extending to the shock bearing fluid intake position. Increasing fluid pressure as the pump plunger extends, during the plunger up-stroke to the pump plunger discharge position, results in the retraction of the shock bearing to the shock bearing fluid outflow position.

The shock bearing displacement position varies dynamically as a result of variations in the object fluid dynamic pressure and the resultant variations in the dynamic bearing pressure loading imposed on the bearing pressure surface. More importantly, the instantaneous variations in the object fluid dynamic pressure due to fluid pressure shock waves imparted to the object fluid, which are inherent in the operation of a high RPM, high pressure plunger pump, particularly in the use of a high RPM, high pressure plunger pump for certain types of loads, pose a problem for certain uses of this type of pump. Regardless of the source of the fluid pressure shock waves, the extremely high, repetitive instantaneous pressures resulting from the fluid pressure shock waves can have a detrimental effect on fluid system components. The objective of the fluid shock pressure dampening of the present invention is to substantially reduce the shock fluid pressure variations, i.e. reduce the peak shock fluid pressure increase, which would result for a plunger pump having a fixed bearing and no bearing dampener mechanism.

The energy from the plunger stored in the bearing dampener mechanism during the plunger up-stroke, with the shock bearing being compressed to the shock bearing fluid outflow position, is released as the plunger up-stroke is completed, the plunger moves through the plunger down stroke and the shock bearing is released to the shock bearing fluid intake position. Similarly, the energy stored in the bearing dampener mechanism during the instantaneous increase in pressure, the peak shock fluid pressure increase, resulting from a fluid pressure shock wave, is released during the corresponding instantaneous decrease in pressure, the peak shock fluid pressure decrease, during the corresponding reduction portion of the fluid pressure shock wave. The shock fluid pressure variations resulting from a shock wave which may have maximum positive and negative pressure variations imposed on the dynamic fluid pressure of the object fluid, may be reduced by the bearing dampener mechanism of the present invention, reducing the shock wave to the dampened shock wave having a dampened peak shock pressure increase and a dampened peak shock pressure decrease. Hence, the bearing dampener mechanism of the present invention may dampen the shock wave, which would result for a plunger pump having a fixed plunger bearing and no bearing dampener mechanism, to a dampened shock wave.

The compression of the bearing dampener mechanism, the shock bearing position, and the shock bearing displacement, may vary in response to the instantaneous object fluid pressure, which is the composite of the instantaneous dynamic pressure from the normal cyclical variations of the plunger and the instantaneous shock fluid pressure variation. The effect of the bearing dampener mechanism on the resultant composite dynamic pressure will depend on the components and characteristics of the components of the bearing dampener mechanism, such as the characteristics of the shock spring, the characteristics of the hydraulic dampener assembly, or the characteristics of the shock spring and the hydraulic dampener assembly of the hybrid dampener assembly. The dampener spring, as well as any other hydraulic or mechanical components of the shock dampening mechanism will be selected to achieve, as nearly as possible, the desired shock wave amplitude reduction.

An alternative embodiment of the shock pump provides for the shock spring to be positioned between a reciprocating dampener support, which is anchored to and reciprocates with the pump plunger, and the shock bearing. As the pump plunger moves from the plunger down position to the plunger up position, the reciprocating dampener support moves from a reciprocating support down position to a reciprocating support up position. As the reciprocating dampener support moves to the reciprocating support up position, the increasing fluid pressure, including any shock pressure, results in shock bearing up-stroke compression and a corresponding compression of the shock spring.

### BRIEF DESCRIPTION OF THE DRAWINGS

FIG. 1 is a longitudinal cross-section of a preferred embodiment of the shock pump of the present invention with the pump plunger in the plunger down position and the shock bearing extended to the shock bearing fluid intake position, the shock pump having a shock bearing assembly incorporating a shock dampening mechanism which is a bearing dampener mechanism with a shock spring.

FIG. 2 is a longitudinal cross-section of the preferred embodiment of the shock pump of the present invention shown in FIG. 1 with the pump plunger in the plunger up position and the shock bearing retracted to the shock bearing fluid outflow position.

FIG. 3 is a lateral cross-section of a cylindrically shaped pressure chamber of a preferred embodiment of the shock pump of the present invention.

FIG. 4 is a lateral cross-section of a cylindrically shaped pressure chamber of a preferred embodiment of the shock pump of the present invention with a shock chamber wall fillet in the shock chamber longitudinal wall slidably mated with a corresponding shock bearing slot in the shock bearing periphery, thereby preventing shock bearing rotation.

FIG. 5 is a longitudinal cross-section detail of the shock bearing and shock spring of a preferred embodiment of the shock pump of the present invention.

FIG. 6 is a longitudinal cross-section of an alternative preferred embodiment of the shock pump of the present invention having a shock bearing assembly incorporating a shock dampening mechanism which is a hydraulic dampening system with a hydraulic dampening system.

FIG. 7 is a longitudinal cross-section of an alternative preferred embodiment of the shock pump of the present invention having a shock bearing assembly incorporating a shock dampening mechanism which is a hybrid dampener assembly incorporating a shock spring and a hydraulic dampener assembly.

FIG. 8 is a graphical illustration of instantaneous variations in the object fluid dynamic pressure due to fluid pressure shock waves imparted to the object fluid, which are inherent in the operation of a high RPM, high pressure plunger pump.

FIG. 9 is a longitudinal cross-section illustration of an example embodiment of an external fluid dampening assembly, utilizing a dampener air chamber, which may be incorporated with the hydraulic dampener assembly of FIG. 6, or the hybrid dampener assembly of FIG. 7.

FIG. 10 is a longitudinal cross-section illustration of an example embodiment of an external fluid dampening assembly, utilizing a dampener spring chamber and a dampener spring, which may be incorporated with the hydraulic dampener assembly of FIG. 6, or the hybrid dampener assembly of FIG. 7.

FIG. 11 is a cross-section detail illustration of an example alternative fluid manifold for the shock pump of the present invention incorporating a single fluid port to the pressure chamber.

FIG. 12 is a longitudinal cross-section of an alternative preferred embodiment of the shock pump of the present invention incorporating a reciprocating dampener support, the shock bearing assembly incorporating a shock dampening mechanism which is a bearing dampener mechanism with a shock spring, the shock spring positioned between the reciprocating dampener support and the shock bearing, the pump plunger shown in the plunger down position and the reciprocating dampener support shown in the reciprocating support down position.

FIG. 13 is a longitudinal cross-section of the alternative preferred embodiment of the shock pump of the present invention shown in FIG. 12 with the pump plunger shown in the plunger up position and the reciprocating dampener support shown in the reciprocating support up position.

### DETAILED DESCRIPTION

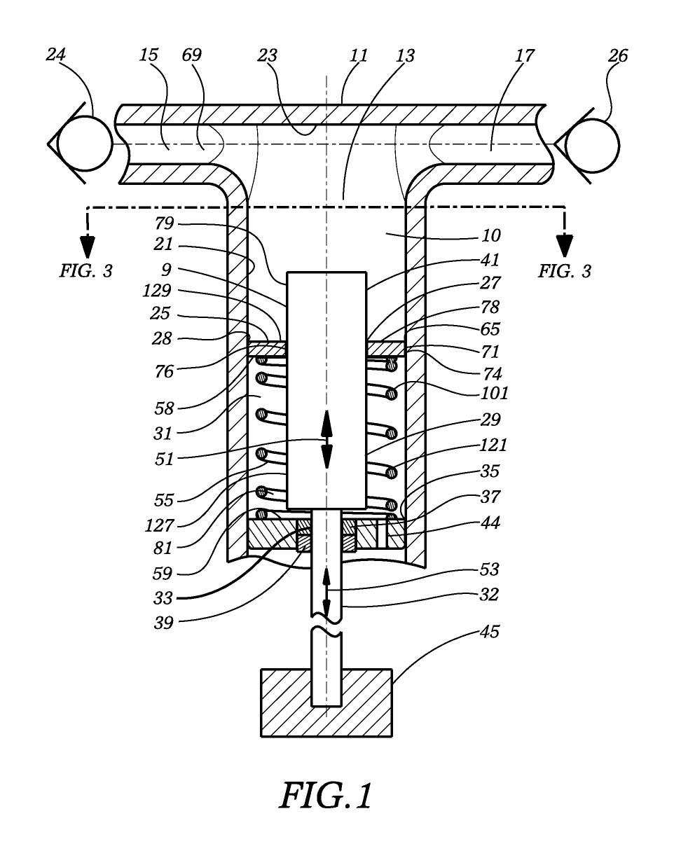

Referring first to FIG. 1, a preferred embodiment of high pressure, high temperature, shock pressure dampening plunger pump 11 of the present invention is shown. For the purposes of this specification, including the claims, the term “shock pump” shall be defined to mean the high pressure, high temperature, shock pressure dampening plunger pump 11 of the present invention. The preferred embodiment of the shock pump 11 shown in FIG. 1 has a plunger chamber 10 which includes a pressure chamber 13 and a shock chamber 31. The pressure chamber 13 may have a pressure chamber intake port 15 and a pressure chamber outlet port 17. As shown for the preferred embodiment of the shock pump 11 illustrated in FIG. 1, the pressure chamber 13 may be cylindrically shaped with a pressure chamber longitudinal wall 21, a pressure chamber end wall 23, and a shock bearing 25. The shock bearing 25 separates the pressure chamber 13 from the shock chamber 31 in the plunger chamber 10. The shock bearing 25 has a plunger port 27.

The pressure chamber intake port 15 and the pressure chamber outlet port 17 may be positioned in the pressure chamber longitudinal wall 21 adjacent to the pressure chamber end wall 23, as shown for the preferred embodiment of the shock pump 11 illustrated in FIG. 1. An intake check valve 24 positioned upstream of the pressure chamber intake port 15 may provide for object fluid 69 to flow into the pressure chamber 13 during down strokes of the pump plunger 9 while preventing outflow of object fluid 69 through the pressure chamber intake port 15 during the up-strokes of the pump plunger 9. Similarly, an outflow check valve 26 may provide for object fluid 69 to flow from the pressure chamber 13 through the pressure chamber outlet port 17 during up-strokes of the pump plunger 9 while preventing inflow of object fluid 69 through the outlet port 17 during the down strokes of the pump plunger 9.

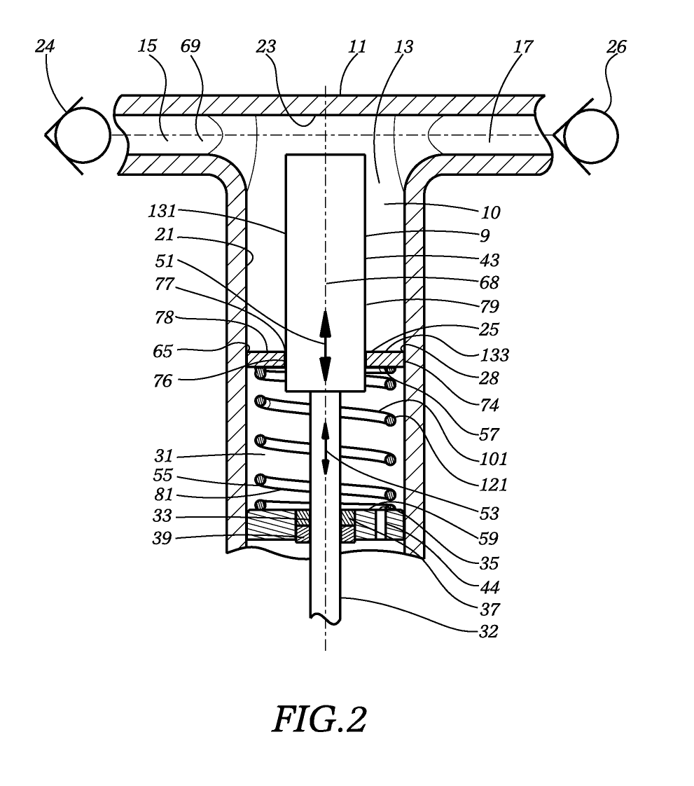

A pump plunger 9 is positioned in the plunger chamber 10, partially in the pressure chamber 13 and partially in a shock chamber 31, in a plunger reciprocating position 29 by a plunger rod 32 which passes through a plunger rod port 33 in a shock chamber end wall 35 and connects the pump plunger 9 to a plunger drive mechanism 45. The plunger rod port 33 may have a plunger seal 37 to seal the shock chamber 31 against fluid and pressure loss from the shock chamber 31 and a plunger rod bearing 39 which maintains the positioning of the pump plunger 9 as the pump plunger 9 reciprocates between the plunger down position 41 as shown in FIG. 1 and the plunger up position 43 as shown in FIG. 2. The plunger rod 32 may connect the pump plunger 9 to a plunger drive mechanism 45 preferably positioned outside the shock chamber 31. The plunger seal 37 may control fluid leakage and the plunger rod bearing 39 may provide for proper positioning and protection of the plunger rod 32, the pump plunger 9, and the plunger drive mechanism 45 as a plunger drive mechanism 45 imposes a repetitive, reciprocating plunger motion 51 through the plunger rod reciprocating motion 53. A shock chamber fluid drain 44 may provide for leaked fluid to be drained from the shock chamber 31. In view of the disclosures of this specification and the drawings, persons of ordinary skill in the art will have knowledge of various reciprocating plunger drive mechanisms 45 that may serve as an appropriate plunger drive mechanism 45 for the pump plunger 9 of the shock pump 11 of the present invention, as well as various mechanisms for connecting the plunger drive mechanism 45 to the pump plunger 9 and providing for the plunger drive mechanism 45 to impart reciprocating motion on the pump plunger 9. The depiction of the plunger drive mechanism 45 and the plunger rod 32, and the interconnection of the plunger drive mechanism 45, the plunger rod 32, and the pump plunger 9 shown in FIG. 1 and FIG. 2, is merely illustrative and other reciprocating drive connection mechanisms for interconnecting the pump plunger 9 of the shock pump 11 of the present invention with a plunger drive mechanism 45 will be obvious to persons of ordinary skill in the art, in view of the disclosures of this specification and the drawings.

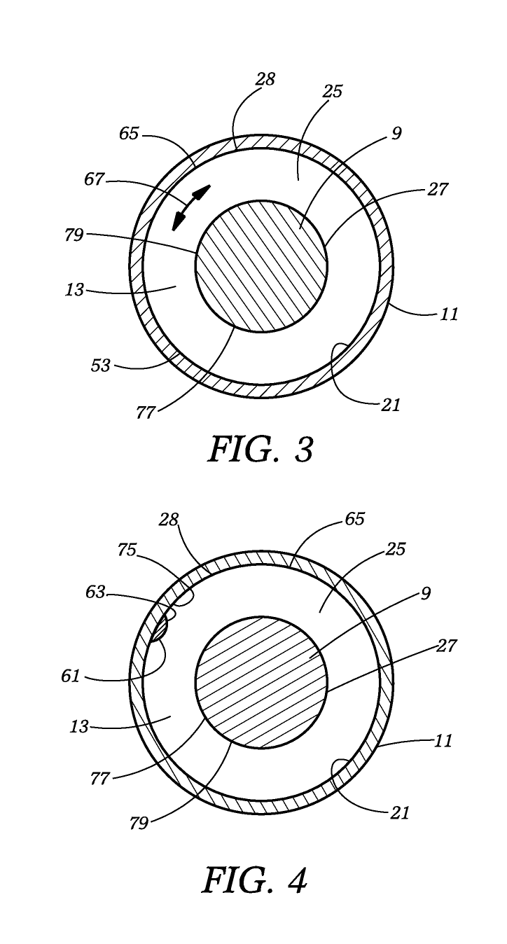

While the pressure chamber 13 of the embodiment shown in FIG. 1 is cylindrically shaped, i.e. has a circular chamber lateral cross section 53 as shown in FIG. 3, the shock bearing 25 having a circular shock bearing periphery 65 in contact with the cylindrical pressure chamber longitudinal wall 21 in shock bearing peripheral contact surface 28, other embodiments may incorporate non-circular chamber lateral cross sections such as a square, hexagonal or octagonal cross section. An advantage of using a non-cylindrical pressure chamber is that shock bearing rotation 67 of the shock bearing 25 is prevented. Hence, the use of a non-cylindrical pressure chamber 13 and, hence, a non-circular shock bearing 25 may result in a less complex shock dampening mechanism 55, a less complex shock bearing interface 57 of the bearing dampener mechanism 101 of the shock dampening mechanism 55 with the shock bearing 25 at the bearing dampener interface 58, which may be an interconnection of the shock bearing 25 and the bearing dampener mechanism 101, and a less complex chamber end interface 59 of the bearing dampener mechanism 101 of the shock dampening mechanism 55 with the shock chamber end wall 35, which may be an interconnection of the bearing dampening mechanism 101 and the shock chamber end wall 35. Depending on the structure of the shock dampening mechanism 55 and the structure of the shock chamber 31, the bearing dampener mechanism 101 may merely contact the shock bearing 25 and the shock chamber end wall 35. For other embodiments, the bearing dampener mechanism 101 may be connected to the shock bearing 25 at the bearing dampener interface 58, may be connected to the shock chamber end wall 35, or may be connected to both. Although the shock bearing 25 shown in FIGS. 1-2 is wafer shaped with a uniform thickness, other embodiments of the shock bearing 25 may have a variable cross-section.

Alternatively, for embodiments of the shock pump 11 of the present invention utilizing a cylindrical shock chamber 31, a shock chamber wall fillet 61 in the shock chamber longitudinal wall 75, as shown in FIG. 4, which may have any of a variety of geometric cross-sections, such as the semi-circular cross-section shown in FIG. 4, may slidably mate with a corresponding shock bearing slot 63 in the shock bearing periphery 65, thereby preventing shock bearing rotation 67. If prevention of shock bearing rotation 67 is deemed necessary or desirable, other mechanisms and methods for the prevention of shock bearing rotation 67 will be obvious to persons of skill in the art in view of the disclosures of this specification and the drawings.

Referring further to FIG. 1, although the pressure chamber 13 and the shock chamber 31, for the preferred embodiment shown, may have the same lateral cross-section, other embodiments may provide for the pressure chamber 13 and the shock chamber 31 to have differing lateral cross-sections. Both the pressure chamber 13 and the shock chamber 31 may have a cylindrical shape with a common central axis 68 but differing diameters, or either or both the pressure chamber 13 and the shock chamber 31 may have a non-circular cross-section.

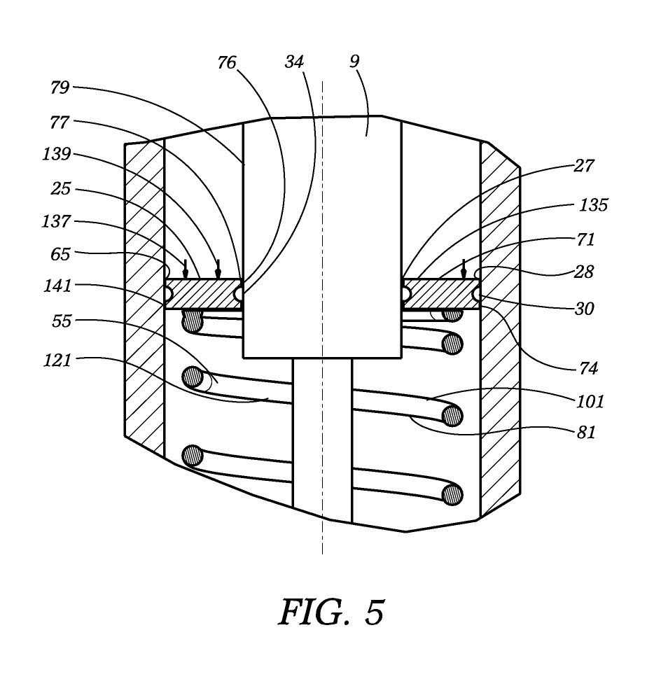

Referring further to FIG. 1 and also to FIG. 5 a preferred embodiment of the shock bearing assembly 71 of the shock pump 11 is shown. The shock bearing assembly 71 may incorporate a shock bearing 25 which may have a shock bearing periphery 65 which is in slidable contact in a shock bearing peripheral contact surface 28 with the shock chamber longitudinal wall 75, and may have a shock bearing inside surface 77 which is in slidable contact with the plunger longitudinal surface 79 of the pump plunger 9 in the plunger port 27. A peripheral seal ring 30 may be incorporated in the shock bearing periphery 65 to enhance the seal and reduce wear at the shock bearing peripheral contact surface 28. Similarly, an inside seal ring 34, may be incorporated in the shock bearing inside surface 77 to enhance the seal and reduce wear at the shock bearing inside surface 77. In view of the disclosures of the drawings and this specification, other mechanisms for the bearing wall interface 74 of the shock bearing 25 and the shock chamber longitudinal wall 75, and other mechanisms for the bearing plunger interface 76 of the shock bearing 25 and the pump plunger 9, providing for the longitudinal movement of the shock bearing 25 in the shock chamber 31 in response to changes in fluid pressure in the pressure chamber 13, will be obvious to persons of ordinary skill in the art.

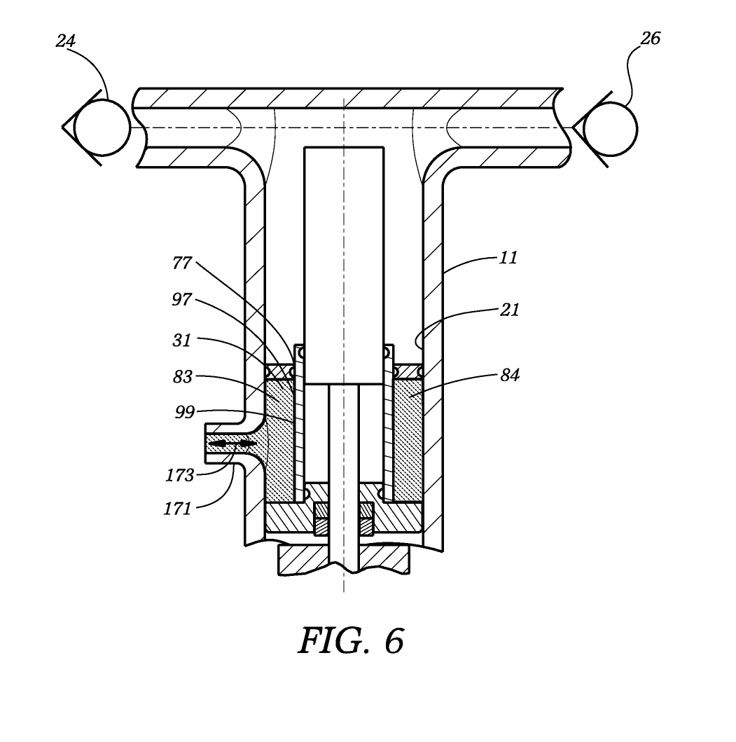

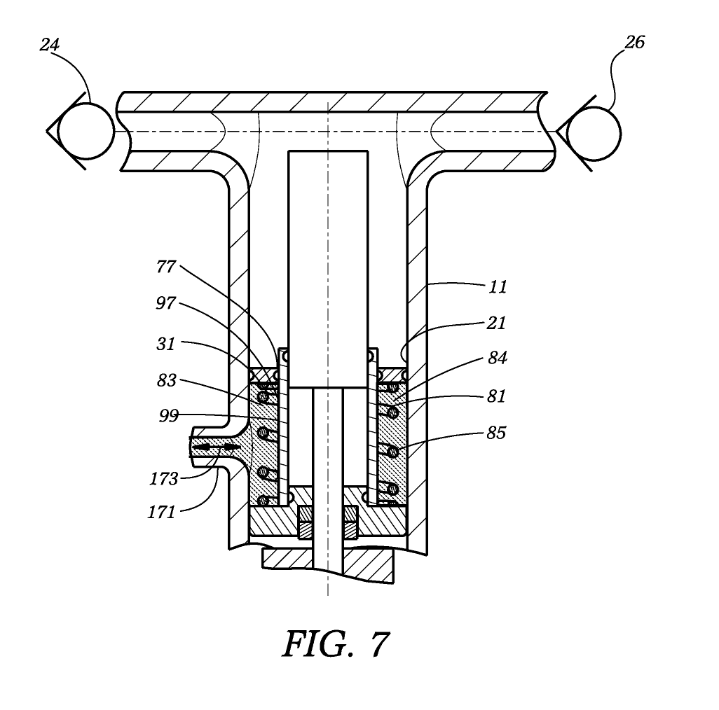

The shock bearing assembly 71 may incorporate a shock dampening mechanism 55 which incorporates a bearing dampener mechanism 101. The bearing dampener mechanism 101 may incorporate a shock spring 81 as shown in FIGS. 1, 2 and 5, may incorporate a hydraulic dampening system such as the hydraulic dampener assembly 83 illustrated in FIG. 6, or may incorporate a hybrid dampener assembly 85 incorporating a shock spring 81 and a hydraulic dampener assembly 83 as illustrated in FIG. 7. For the embodiments of the hydraulic dampener assembly of FIG. 6 and FIG. 7, the shock bearing inside surface 77 may be in slidable contact with the plunger sleeve external surface 99 of the plunger sleeve 97, the plunger sleeve 97 providing for confining the hydraulic dampener fluid 84 to the shock chamber 31 of these embodiments. As illustrated in FIG. 5, an inside seal ring 34 may be incorporated in the shock bearing inside surface 77 to enhance the seal and reduce wear at the shock bearing inside surface 77 in its contact with the plunger sleeve external surface 99.

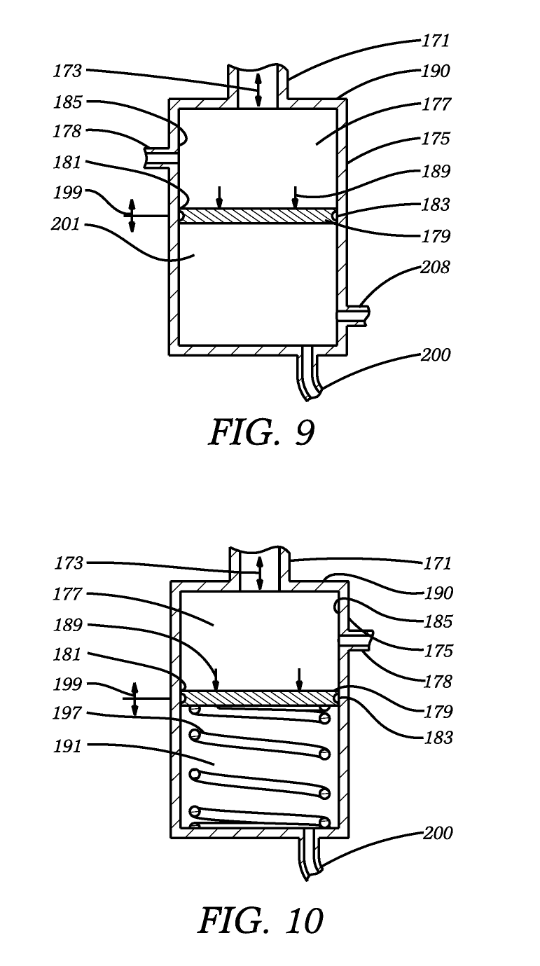

Referring also to FIG. 9 and FIG. 10, example embodiments of an external fluid dampening assembly 190 which may be incorporated with the hydraulic dampener assembly 83 of the alternative embodiment of the shock pump 11 shown in FIG. 6, or the alternative embodiment of the shock pump 11 shown in FIG. 7 having a hybrid dampener assembly 85. Hydraulic pressure variations in the hydraulic dampener fluid 84 may be transmitted from the shock chamber 31 of the hydraulic dampener assembly 83 to the external dampener assembly 190 through hydraulic dampener fluid 84 in the dampening fluid line 171.

Other alternative embodiments of the bearing dampener mechanisms 121 will be obvious to persons of ordinary skill in the art in view of the disclosures of this specification and the drawings.

For the preferred embodiment of the bearing dampener mechanism 101, the shock spring 81, illustrated in FIGS. 1-3, as the object fluid 69, which may be compressible or non-compressible fluid, is introduced to the pressure chamber 13 during the plunger down stroke as the pump plunger 9 moves to plunger intake position 127 as shown in FIG. 1, the diminished fluid pressure in the pressure chamber 13 may result in the shock bearing 25 extending to the shock bearing fluid intake position 129 as shown in FIG. 1. Increasing fluid pressure as the pump plunger 9 extends, during the plunger up-stroke to the pump plunger discharge position 131 shown in FIG. 2, results in the retraction of the shock bearing 25 to the shock bearing fluid outflow position 133 as shown in FIG. 2.

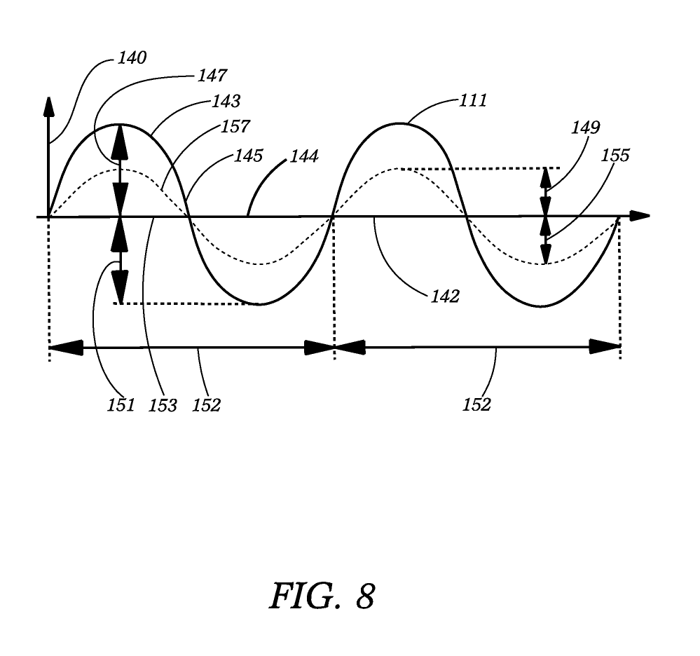

Referring again to FIG. 5, the shock bearing displacement position 135 varies dynamically as a result of variations in the object fluid dynamic pressure 137 and the resultant variations in the dynamic bearing pressure loading 139 imposed on the bearing pressure surface 141. More importantly, the instantaneous variations in the object fluid dynamic pressure 137 due to fluid pressure shock waves 143 illustrated in FIG. 8, imparted to the object fluid 69, which are inherent in the operation of a high RPM, high pressure plunger pump, particularly in the use of a high RPM, high pressure plunger pump for certain types of loads, pose a problem for certain uses of this type of pump. Regardless of the source of the fluid pressure shock waves 143, the extremely high, repetitive instantaneous pressures resulting from the fluid pressure shock waves 143 can have a detrimental effect on fluid system components.

Referring to FIG. 8, it should be noted that, for the fluid pressure shock wave 143 illustrated, the shock wave pressure component 140 of the shock wave 143 as a function of time 142 is illustrated superimposed on an instantaneous baseline pressure 144. A sinusoidal variation of the shock fluid pressure variation 145 is illustrated. However, a fluid pressure shock wave 143 may have a variety of wave forms, including irregular wave forms which vary in form over the shock wave length 152, and which have a variable shock wave length 152 and a variable amplitude, i.e. a variable peak shock fluid pressure variation 147 attributable to the shock wave 143. The objective of the fluid shock pressure dampening is to substantially reduce the shock fluid pressure variations 145, i.e. reduce the peak shock fluid pressure variation 147, which would result for a plunger pump having a fixed bearing and no bearing dampener mechanism 101, to the dampened peak shock fluid pressure increase 149 as illustrated in FIG. 8.

Referring further to FIGS. 1-2, the energy from the plunger 9 stored in the bearing dampener mechanism 101 during the plunger up-stroke, with the shock bearing 25 being compressed to the shock bearing fluid outflow position 133 as shown in FIG. 1, is released as the plunger up-stroke is completed, as shown in FIG. 2, the plunger 9 moves through the plunger down stroke and the shock bearing 25 is released to the shock bearing fluid intake position 129. Similarly, the energy stored in the bearing dampener mechanism 101 during the instantaneous increase in pressure, the peak shock fluid pressure variation 147, resulting from a fluid pressure shock wave 143, as shown in FIG. 8, is released during the corresponding instantaneous decrease in pressure, the peak shock fluid pressure decrease 151, during the corresponding reduction portion of the fluid pressure shock wave 143 as indicated in FIG. 8. The shock fluid pressure variations 145 resulting from a shock wave 143 which may have maximum positive and negative peak shock fluid pressure variations 147, 151 imposed on the dynamic fluid pressure 153 of the object fluid 69, may be reduced by the bearing dampener mechanism 101 of the present invention, reducing the shock wave 143 to the dampened shock wave 157 having dampened peak shock pressure increase 149 and dampened peak shock pressure decrease 155. Hence, the bearing dampener mechanism 101 of the present invention may dampen the shock wave 143, which would result for a plunger pump 11 having a fixed plunger bearing and no bearing dampener mechanism 101, to the dampened shock wave 157 illustrated in FIG. 8.

The compression of the bearing dampener mechanism 101, the shock bearing position 78, and the shock bearing displacement 135 may vary in response to the instantaneous object fluid pressure, which is the composite of the instantaneous dynamic pressure from the normal cyclical variations of the plunger 9 and the instantaneous shock fluid pressure variation 145. The effect of the bearing dampener mechanism 101 on the resultant composite dynamic pressure will depend on the components and characteristics of the components of the bearing dampener mechanism 101, including the characteristics of the shock spring 81 for the embodiment shown in FIGS. 1, 2 and 5, the characteristics of the hydraulic dampener assembly 83 illustrated in FIG. 6, or the characteristics of the shock spring 81 and the hydraulic dampener assembly 83 of the hybrid dampener assembly 85 illustrated in FIG. 7.

Referring further to FIG. 9 and FIG. 10, as discussed above, example embodiments of an external fluid dampening assembly 190 which may be utilized with the alternative embodiment of the shock pump 11 shown in FIG. 6 having a hydraulic dampener assembly 83, or the alternative embodiment of the shock pump 11 shown in FIG. 7 having a hybrid dampener assembly 85 are illustrated. Hydraulic pressure variations in the hydraulic dampener fluid 84 may be transmitted from the shock chamber 31 to the external dampener assembly 190 of the hydraulic dampener assembly 83 through hydraulic dampener fluid 84 in the dampening fluid line 171. Bi-directional dampener fluid flow 173 between the shock chamber 31 and the dampener fluid chamber 177 of the external dampener assembly 190 in response to dynamic pressure variations and shock fluid pressure variations 145 experienced by the object fluid 69 in the pressure chamber 13 induce a variable dampener fluid pressure 189 on the dampener assembly bearing 179 and, hence, a variable dampener bearing position 199 and a variable compression of the dampener air of the dampener air chamber 201 of FIG. 9, or a variable compression of the dampener spring 197 of the embodiment of the external dampener assembly 190 shown in FIG. 10.

A dampener bearing seal ring 183 may provide for enhanced seal and reduced wear at the contact of the dampener bearing periphery 181 with the dampener chamber longitudinal wall 185. A dampener fluid leakage drain 200 may be provided for the dampener air chamber 201 of FIG. 9 or the dampener spring chamber 191 of FIG. 10. A dampener fluid port 178 may provide for the addition or removal of hydraulic dampener fluid 84 for the hydraulic dampener assembly 83 of the embodiment of FIG. 9 or the embodiment of FIG. 10. A dampener air port 208 may provide for air to be added or removed from the dampener air chamber 201 of the embodiment of FIG. 9, thereby providing for the operating pressure of the dampener air chamber 201 to be maintained at or adjusted to a desired level.

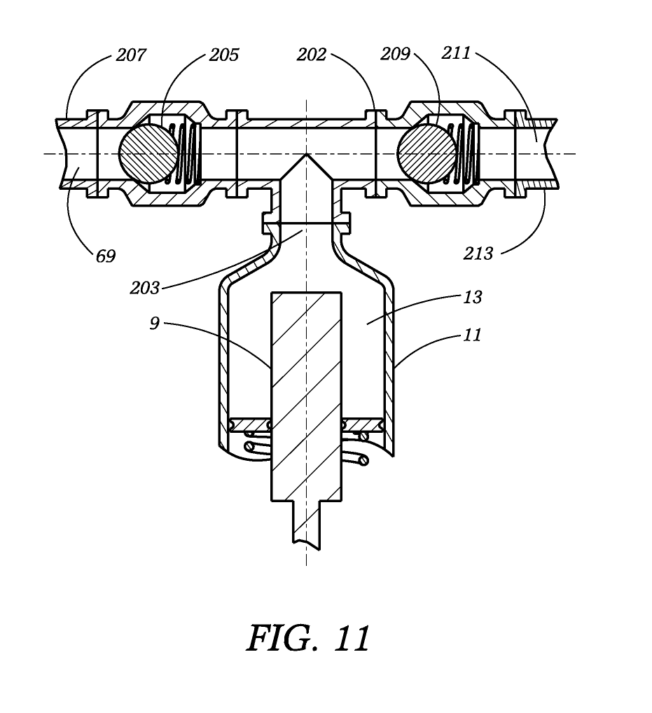

Referring now to FIG. 11, an alternative fluid manifold 202 incorporating a single fluid port 203 to the pressure chamber 13 whereby object fluid 69 enters the pressure chamber 13 during the plunger downstroke and object fluid 69 exits during the plunger up-stroke. For this embodiment, typically a manifold inflow check valve 205 will provide for object fluid 69 inflow to the pressure chamber 13 from the object fluid supply line 207 and will prevent reverse flow in the object fluid supply line 207. Similarly, the discharge check valve 209 will provide for pressurized discharge of pressurized object fluid 211 from the pressure chamber 13 to the fluid discharge line 213 and will not allow a discharge fluid reverse flow from the fluid discharge line 213 to the pressure chamber 13. The embodiment of the shock pump 11 shown in FIG. 11 may increase the shock fluid pressure variations 145 and the peak shock pressure 149 due to the repetitive, abrupt changes in direction of the object fluid flow in the fluid port 203.

Referring again to FIG. 8, typically the fluid pressure variation frequency 111 resulting from shock waves induced by the plunger cycling will be of a higher frequency than the RPM of the pump plunger 9. Similarly, the pressure variations frequency 111 of a shock wave 143 imposed by a particular load during the rod pump plunger up-stroke will also be a higher frequency than the RPM rate of the pump plunger 9. Depending upon the measure of the anticipated shock loading conditions to be experienced by the shock pump 11 of the present invention, as well, as the normal operating pressure conditions for the shock pump 11 of the present invention, as well as, the normal operating conditions for the shock pump 11, the dampener spring 115, as well as any other hydraulic or mechanical components of the shock dampening mechanism 55 will be selected to achieve, as nearly as possible, the desired shock wave amplitude reduction, as illustrated in FIG. 8.

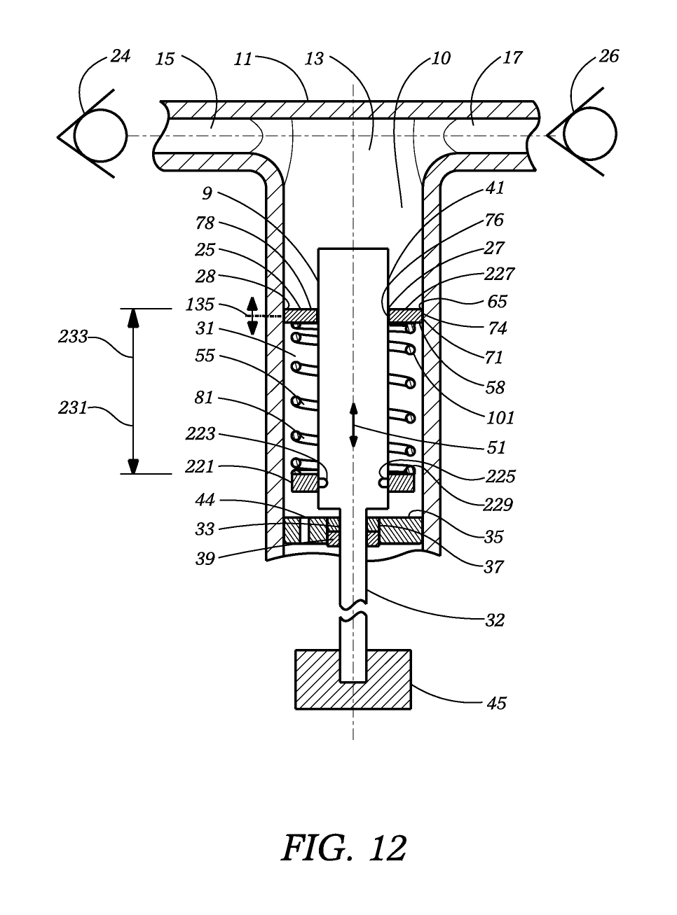

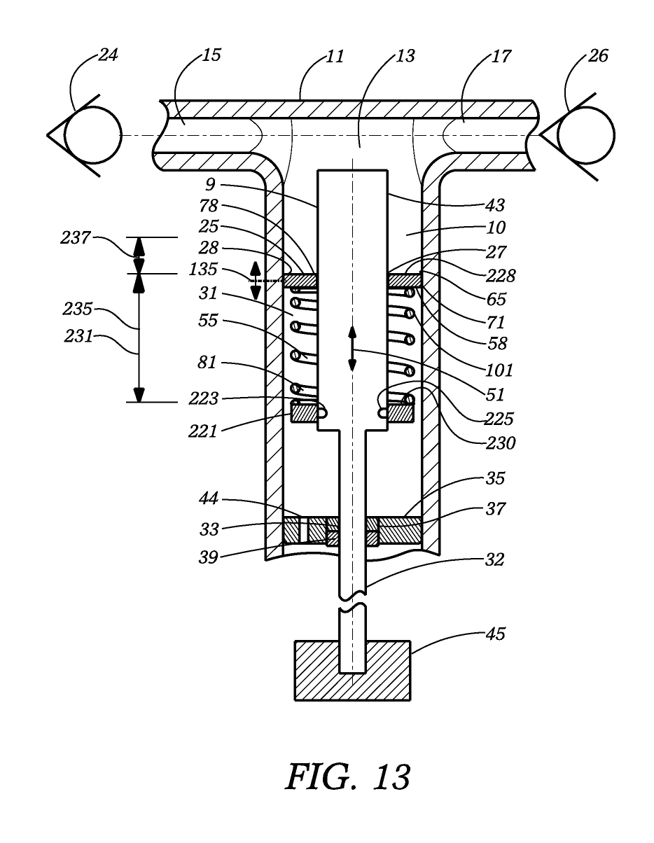

Referring now to FIG. 12 and FIG. 13, an alternative embodiment of the shock pump 11 of the present invention is shown. For this alternative embodiment, the shock spring 81 is positioned between a reciprocating dampener support 221, which may have a reciprocating support key 223 which may be mated with a plunger support groove 225, and the shock bearing 25. As the plunger 9 moves from the plunger down position 41 as shown in FIG. 12 to the plunger up position 43 shown in FIG. 13, the reciprocating dampener support 221 moves from a reciprocating support down position 229 to a reciprocating support up position 230. As the reciprocating dampener support moves to the reciprocating support up position 230, the increasing fluid pressure, including any shock pressure, in the pressure chamber 13 results in shock bearing up-stroke compression 237 as shown in FIG. 13, which results in a corresponding compression of the shock spring 81. The shock bearing reciprocating support separation 231 is compressed from the plunger down support separation 233 shown in FIG. 12 to the plunger up support separation 235 as shown in FIG. 13. Accordingly, referring again to FIG. 8, the alternative embodiment of the shock pump 11 shown in FIG. 12 and FIG. 13, provides for shock pressure dampening of a fluid pressure shock wave 143, which may have maximum positive and negative pressure variation 147, 151 imposed on the dynamic fluid pressure 153 of the object fluid 69, to be reduced by the bearing dampener mechanism 101 of the present invention, reducing the shock wave 143 to the dampened shock wave 157 having dampened peak shock pressure increase 149 and dampened peak shock pressure decrease 155 as illustrated in FIG. 8.

In view of the disclosures of this specification and the drawings, other embodiments and other variations and modifications of the embodiments described above will be obvious to a person skilled in the art. Therefore, the foregoing is intended to be merely illustrative of the invention and the invention is limited only by the following claims and the doctrine of equivalents.

What is claimed is:

1. A positive displacement, shock dampening, plunger pump, the plunger pump comprising:
a plunger chamber comprising a pressure chamber and a shock chamber,
the plunger chamber having a plunger chamber longitudinal wall, the pressure chamber having one or more object fluid ports for object fluid intake and object fluid outflow respectively, and the shock chamber having a shock chamber end wall;
a shock bearing slidably positioned in the plunger chamber, the shock bearing having a bearing wall interface with the plunger chamber longitudinal wall;
a bearing dampener mechanism positioned in the shock chamber and having a bearing dampener interface with the shock bearing and a chamber end interface with the shock chamber end wall;
a pump plunger reciprocally positioned in the plunger chamber and extending from the shock chamber to the pressure chamber through a plunger port in the shock bearing, the plunger having a bearing plunger interface between the plunger port and the plunger longitudinal surface; and
a reciprocating drive connection mechanism for interconnecting the pump plunger with a plunger drive mechanism.

2. A positive displacement, shock dampening, plunger pump as recited in claim 1 wherein the bearing dampener mechanism incorporates a shock spring.

3. A positive displacement, shock dampening, plunger pump as recited in claim 1 wherein the shock bearing has a shock bearing periphery in slidable contact with the plunger chamber longitudinal wall, the shock bearing having a bearing pressure surface and having a bearing dampener surface, wherein the bearing dampener mechanism has a first dampener contact with the bearing dampener surface and a second dampener contact with the shock chamber end wall, and wherein the shock bearing has a shock bearing inside surface which is in slidable contact with the plunger longitudinal surface.

4. A positive displacement, shock dampening, plunger pump, the plunger pump comprising:
a plunger chamber comprising a pressure chamber and a shock chamber,
the plunger chamber having a plunger chamber longitudinal wall, the pressure chamber having one or more object fluid ports for object fluid intake and object fluid outflow respectively, and the shock chamber having a shock chamber end wall;
a shock bearing slidably positioned in the plunger chamber, the shock bearing having a shock bearing periphery in slidable contact with the plunger chamber longitudinal wall, the shock bearing having a bearing pressure surface and a bearing dampener interface;
a bearing dampener mechanism positioned in the shock chamber and having a bearing dampener interface with the shock bearing and a chamber end interface with the shock chamber end wall;
a pump plunger reciprocally positioned in the plunger chamber and extending from the shock chamber to the pressure chamber through a plunger port in the shock bearing, the plunger having a plunger longitudinal surface and the plunger port having a shock bearing inside surface which is in slidable contact with the plunger longitudinal surface; and
a reciprocating drive connection mechanism for interconnecting the pump plunger with a plunger drive mechanism.

5. A positive displacement, shock dampening, plunger pump as recited in claim 4 wherein the bearing dampener mechanism incorporates a shock spring.

6. A positive displacement, shock dampening, plunger pump as recited in claim 4 wherein the bearing dampener mechanism has a first dampener contact with the bearing dampener surface and a second dampener contact with the shock chamber end wall, and wherein the shock bearing has a shock bearing inside surface which is in slidable contact with the plunger longitudinal surface.

7. A positive displacement, shock dampening, plunger pump, the plunger pump comprising:
a plunger chamber comprising a pressure chamber and a shock chamber,
the plunger chamber having a plunger chamber longitudinal wall, the pressure chamber having one or more object fluid ports for object fluid intake and object fluid outflow respectively, and the shock chamber having a shock chamber end wall;
a shock bearing slidably positioned in the plunger chamber, the shock bearing having a bearing wall interface with the plunger chamber longitudinal wall;
a pump plunger reciprocally positioned in the plunger chamber and extending from the shock chamber to the pressure chamber through a plunger port in the shock bearing, the plunger having a plunger longitudinal surface, and the plunger pump having a bearing plunger interface between the plunger port and the plunger longitudinal surface;
a reciprocating dampener support attached in the shock chamber to the plunger longitudinal surface;
a bearing dampener mechanism positioned in the shock chamber and having a bearing dampener interface with the shock bearing and a reciprocating support interface with the reciprocating dampener support; and
a reciprocating drive connection mechanism for interconnecting the pump plunger with a plunger drive mechanism.

8. A positive displacement, shock dampening, plunger pump as recited in claim 7 wherein the bearing dampener mechanism incorporates a shock spring.

9. A positive displacement, shock dampening, plunger pump as recited in claim 7 wherein the shock bearing has a shock bearing periphery in slidable contact with the plunger chamber longitudinal wall, the shock bearing having a bearing pressure surface and having a bearing dampener surface, wherein the bearing dampener mechanism has a first dampener contact with the bearing dampener surface and a second dampener contact with the reciprocating dampener support, and wherein the shock bearing has a shock bearing inside surface which is in slidable contact with the plunger longitudinal surface.

10. A positive displacement, shock dampening, plunger pump, the plunger pump comprising:
a plunger chamber comprising a pressure chamber and a shock chamber,
the plunger chamber having a plunger chamber longitudinal wall, the pressure chamber having one or more object fluid ports for object fluid intake and object fluid outflow respectively;
a shock bearing slidably positioned in the plunger chamber, the shock bearing having a shock bearing periphery in slidable contact with the plunger chamber longitudinal wall, the shock bearing having a bearing pressure surface and a bearing dampener interface;
a pump plunger reciprocally positioned in the plunger chamber and extending from the shock chamber to the pressure chamber through a plunger port in the shock bearing, the plunger having a plunger longitudinal surface and the plunger port having a shock bearing inside surface which is in slidable contact with the plunger longitudinal surface;
a reciprocating dampener support attached in the shock chamber to the plunger longitudinal surface;
a bearing dampener mechanism positioned in the shock chamber and having a bearing dampener interface with the shock bearing and a reciprocating support interface with the reciprocating dampener support; and
a reciprocating drive connection mechanism for interconnecting the pump plunger with a plunger drive mechanism.

11. A positive displacement, shock dampening, plunger pump as recited in claim 10 wherein the bearing dampener mechanism incorporates a shock spring.

12. A positive displacement, shock dampening, plunger pump, the plunger pump comprising:
a plunger chamber comprising a pressure chamber and a shock chamber,
the plunger chamber having a plunger chamber longitudinal wall, the pressure chamber having one or more object fluid ports for object fluid intake and object fluid outflow respectively, and the shock chamber having a shock chamber end wall;
a shock bearing slidably positioned in the plunger chamber, the shock bearing having a bearing wall interface with the plunger chamber longitudinal wall;
a bearing hydraulic dampener assembly hydraulically interconnected with the shock chamber and having a bearing hydraulic dampener interface with the shock bearing;
a pump plunger reciprocally positioned in the plunger chamber and extending from a plunger sleeve positioned in the shock chamber to the pressure chamber through a plunger sleeve port in the shock bearing, the plunger sleeve having a bearing plunger sleeve interface between the shock bearing inside surface and the plunger sleeve external surface of the plunger sleeve; and
a reciprocating drive connection mechanism for interconnecting the pump plunger with a plunger drive mechanism.

13. A positive displacement, shock dampening, plunger pump, the plunger pump comprising:
a plunger chamber comprising a pressure chamber and a shock chamber,
the plunger chamber having a plunger chamber longitudinal wall, the pressure chamber having one or more object fluid ports for object fluid intake and object fluid outflow respectively, and the shock chamber having a shock chamber end wall;
a shock bearing slidably positioned in the plunger chamber, the shock bearing having a bearing wall interface with the plunger chamber longitudinal wall;
a bearing hybrid dampener assembly hydraulically interconnected with the shock chamber and having a bearing dampener interface with the shock bearing;
a pump plunger reciprocally positioned in the plunger chamber and extending from a plunger sleeve positioned in the shock chamber to the pressure chamber through a plunger sleeve port in the shock bearing, the plunger sleeve having a bearing plunger sleeve interface between the shock bearing inside surface and the plunger sleeve external surface of the plunger sleeve; and
a reciprocating drive connection mechanism for interconnecting the pump plunger with a plunger drive mechanism.

14. A positive displacement, shock dampening, plunger pump as recited in claim 13 wherein the bearing hybrid dampener assembly incorporates a shock spring.
